(19) United States
(12) Patent Application Publication
(10) Pub. No.: US 2019/0089921 A1
(43) Pub. Date: Mar. 21, 2019

(54) INTERACTIVE TELEPRESENCE SYSTEM

(71) Applicant: Fulvio DOMINICI, Grugliasco (IT)

(72) Inventor: Fulvio DOMINICI, Grugliasco (IT)

(21) Appl. No.: 16/075,512

(22) PCT Filed: Feb. 3, 2017
(86) PCT No.: PCT/IB2017/050587

§ 371 Date: Aug. 3, 2018

(30) Foreign Application Priority Data
Feb. 3, 2016 (IT) 102016000010724

(51) Int. Cl. H04N 5/44; G06F 3/0482; H04N 7/14

(52) U.S. Cl. CPC H04N 5/4403; G06F 3/0482; G06F 3/0488; H04N 7/142; H04N 7/147

(57) ABSTRACT

An interactive telepresence system includes a first device operated by a controlling user and a second device operated by a controlled user, in communication with each other over a telematic communication network. The first and second devices include a data transceiver component, a processing component and a user interface component. The second device further includes a video acquisition component, the peculiarity of which is that the processing component of the second device is configured to convert input data corresponding to one or more commands, intended for the controlled user, to corresponding one or more graphical meta-commands, and in that the user interface component of the second device is configured to display and present to the controlled user a combination of an audiovisual content, which corresponds to a scene acquired by the video acquisition component, with the one or more graphical meta-commands.

### TECHNICAL FIELD

The present disclosure relates to an interactive telepresence system, particularly, but not exclusively, useful and practical in services offered to persons over the internet, or artificial systems, for indirectly manipulating remote objects, for indirectly using or aiding remote machinery and for indirectly driving remote vehicles.

### BACKGROUND

Currently various different solutions are known for telepresence over the internet, which comprise systems for communicating by way of webcams, teleconferencing systems, remotely-operated mobile teleconferencing robots and, more generally, systems for transmitting audiovisual streams.

Conventional communication systems using webcams send what is recorded by one or more video cameras, optionally panned or moved remotely by a user, over the internet. When interactions are possible between a controlling user and a controlled user, these interactions are limited to icons displayed at a random point on a device or apparatus operated by the controlled user, which indicate simple, basic, immediate commands for moving the controlled user or the video capture device or apparatus, i.e. the video acquisition device.

The possibilities for interaction are in this case nonexistent or limited to simple, basic commands, and in fact these systems are commonly used for simple audiovisual dialog between persons located in different places, no matter how distant, or for viewing the current situation in some remote location.

Conventional teleconferencing systems include products that range from simple apps for mobile devices, such as for example smartphones or tablet computers, to complex audiovisual systems, typically provided with multiple video cameras.

In general, these are systems that generate an audiovisual stream, often bidirectional, which makes it possible to display a remote location as if one is effectively there. The best-known example of such systems is the Skype software.

The advanced functionalities offered by these conventional teleconferencing systems usually comprise the ability to pan or move one or more video cameras that film the remote location or the remote scene, or an automatic zoom on the person who is speaking in each instance. In general functionalities are also comprised that make it possible to share physical and/or electronic documents.

The most professional conventional teleconferencing systems further comprise functionalities that make it possible to connect several different remote users, creating a single main audiovisual stream that originates from a speaker or from a teacher and is transmitted to all the other users, in broadcast mode.

The most advanced conventional telepresence systems make it possible to send the controlled user, i.e. to the person in the field, movement commands and/or commands to pan the video capture device or apparatus, usually in the form of icons that appear to the controlled user at any point of the video capture.

Conventional mobile teleconferencing robots represent the most technologically-advanced (and, consequently, the most expensive) case; in general these are products that range from the size of a lawnmower to that of a paint can, and are provided with one or more rods that support a mobile device or a display in order to allow a communication session constituted by an audiovisual stream. These conventional robots, as mentioned, are mobile and can be actuated by a remote user who, by pressing direction buttons, indicates to the robot where to go.

None of these conventional robots are provided with arms or with other manipulation means, therefore enabling only to see and hear, and to be seen and heard, in various different remote places. Furthermore, typically, the mobility of such conventional robots is limited to flat surfaces, therefore they are not capable of using stairs, or moving outside buildings or delimited areas.

Finally, land, sea and air robots are known that make it possible to observe and indirectly remotely manipulate objects by a remote user; in any case these are highly-specialist professional products, very sophisticated, very expensive and very difficult to use.

However, the above conventional telepresence solutions are not devoid of drawbacks, among which is the fact that they do not offer any kind of interactivity, or they offer only reduced interactivity for example by way of complex remote control or command of very expensive robots that are difficult to use, or by way of laborious display of icons for moving and/or panning that guide the controlled user, i.e. the person in the field, step-by-step to a desired point by the controlling user, optionally with a position and/or a video capture orientation indicated by the latter.

In practice, the possibility of interacting with remote objects or machines or of moving the point of view outside of a delimited area are nonexistent or very low. Conventional telepresence solutions do not have icons for manipulating objects in the scene framed and captured, and the position on the screen of the icons for moving and/or panning has no influence on the functionality and on the commands imparted by the controlling user to the controlled user. Using conventional telepresence systems, one can only talk or write in the manner of a chat between persons located in different places, leaving it to the dialog between them to define optionally what to do and how to act, perhaps even speaking in different languages.

Another drawback of conventional telepresence solutions is that it is very difficult to move the point of view, especially in medium to long distances; the only possibility of limited movement is that offered by mobile teleconferencing robots, which however cannot move outside of delimited areas with flat surfaces.

A further drawback of conventional telepresence solutions is the impossibility of indirectly remotely manipulating objects by a remote user. If controlling the position is complex, controlling arms or other means of manipulation is even more so.

Another drawback of conventional telepresence solutions is that the remote control or command of a mobile object brings with it many operational and legal complexities. It is not at all easy to put oneself in the position of the controlled mobile object and be aware of the surrounding environment, and to do this complex telemetry apparatuses, multiple views, and special training are necessary. Consider also the legal problems: who is responsible for an accident caused by a robot, controlled by a remote user, that crosses a city street? Is it the remote user? Or is it the company offering the service?

Another drawback of conventional telepresence solutions is that the parties in communication, be they persons or artificial systems, must necessarily have an apparatus that is compatible and is connected to the internet, or must install an adapted program on their computer or mobile device.

Even purely web-based telepresence services require internet-connected computers, which can be used to access the corresponding web site, and on which to install browser extensions if necessary.

A further drawback of conventional telepresence solutions is that the use of very expensive, highly-specialist professional products, such as for example robots or drones, is extremely complex.

### SUMMARY

The aim of the present disclosure is to overcome the limitations of the known art described above, by devising an interactive telepresence system that makes it possible to obtain effects that are similar or better with respect to those obtainable with conventional solutions, by setting up a telepresence that is effectively interactive, i.e. by recreating in the remote user the sensation, as convincing as possible, of being in a different place from where he/she is physically.

Within this aim, the present disclosure conceives an interactive telepresence system that makes it possible to easily move the point of view, especially in medium to long distances, thus overcoming the limited scope of office meetings, typical of videoconferencing products, and which makes it possible for the remote user to leave buildings or delimited areas and explore outside environments, including urban environments.

The present disclosure devises an interactive telepresence system that enables telemanipulation by the remote user, i.e. the possibility to act physically and indirectly on objects present in the remote environment viewed, for the purpose for example of positioning them differently on the scene in order to observe them better, or in order to buy them, actuate them or modify them.

The present disclosure conceives an interactive telepresence system that does not require the parties in communication, be they persons or artificial systems, to have an apparatus that is compatible and is connected to the internet, or to install an adapted program on their computer or mobile device.

The present disclosure devises an interactive telepresence system that does not have, or at least limits to the minimum, operating complexities, thus facilitating the remote user in having awareness of the surrounding environment, and legal complexities.

The present disclosure conceives an interactive telepresence system that is not limited to precise control, step by step, using basic icons for moving and/or panning, which respectively represent individual movements to move the controlled user in the field and to change the position and/or orientation of video capture, as well as interact with elements in the scene framed and captured.

The present disclosure devises an interactive telepresence system that takes advantage of the fact that the controlling user is controlling a human being, who is able to navigate and move around autonomously in the field and to autonomously pan the video capture device or apparatus, following high-level objectives indicated by the controlling user which require complex sequences of low-level actions.

The present disclosure provides an interactive telepresence system that is highly reliable, easily and practically implemented and low cost.

These advantages which will become better apparent hereinafter are achieved by providing an interactive telepresence system, comprising a first device operated by a controlling user and a second device operated by a controlled user, in communication with each other over a telematic communication network, said first device and said second device comprising data transceiver means, processing means and user interface means, said second device further comprising video acquisition means, characterized in that said processing means of said second device are configured to convert input data corresponding to one or more commands, intended for said controlled user, to corresponding one or more graphical meta-commands, and in that said user interface means of said second device are configured to display and present to said controlled user a combination of an audiovisual content, which corresponds to a scene acquired by said video acquisition means, with said one or more graphical meta-commands, the position of which on said user interface means is decisive in order to transmit high-level commands that summarize and avoid a long sequence of low-level commands for moving and/or panning

### BRIEF DESCRIPTION OF THE DRAWINGS

Further characteristics and advantages of the disclosure will become better apparent from the detailed description of a preferred, but not exclusive, embodiment of the interactive telepresence system according to the disclosure, which is illustrated by way of non-limiting example in the accompanying drawings, wherein:

FIG. 1 is a block diagram that schematically illustrates an embodiment of the interactive telepresence system according to the present disclosure;

FIGS. 2a and 2b are a screenshot of the interface of a first variation of an embodiment of the interactive telepresence system according to the present disclosure, and a corresponding actual view of the controlled user or avatar, both examples;

FIGS. 3a and 3b are a screenshot of the interface of a second variation of an embodiment of the interactive telepresence system according to the present disclosure, and a corresponding actual view of the controlled user or avatar, both examples;

FIGS. 4a and 4b are a screenshot of the interface of a third variation of an embodiment of the interactive telepresence system according to the present disclosure, and a corresponding actual view of the controlled user or avatar, both examples.

### DETAILED DESCRIPTION OF THE DRAWINGS

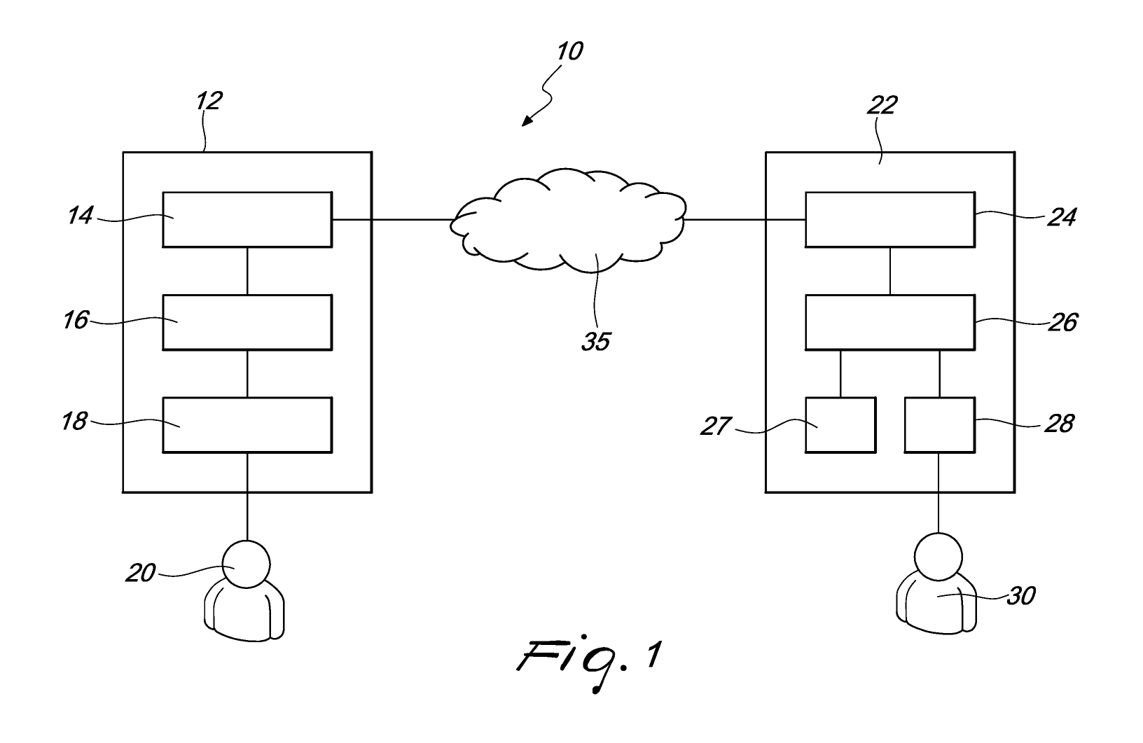

With reference to FIGS. 1-4b, the interactive telepresence system according to the disclosure, generally designated by the reference numeral 10, comprises substantially a first device 12, in the possession of a controlling user or “usar” 20 and operated by the latter, and a second device 22, in the possession of a controlled user or avatar 30 and operated by the latter, the first 12 and the second device 22 being in communication with each other over a telematic communication network 35, such as for example the internet.

The first device 12 is constituted by a mobile device, such as for example a smartphone or a tablet computer, or by a fixed device, such as for example a personal computer, and as mentioned it is in the possession of the controlling user or usar 20, who controls and guides in real time the movements and the actions of the controlled user or avatar 30, according to the methods that will be described below.

The second device 22 is constituted by a mobile device, such as for example a smartphone or a tablet computer, so as to ensure sufficient mobility, and as mentioned is in the possession of the controlled user or avatar 30, which is controlled and guided in its movements and in its actions by the controlling user or usar 20, according to the methods that will be described below.

Note that, in the present disclosure, the controlling user or usar 20 can be a person or an artificial system, and the controlled user or avatar 30 can also be a person or an artificial system (for example a robot).

Both the above mentioned devices 12 and 22 comprise data transceiver means 14, 24, processing means 16, 26 and user interface means 18, 28, the latter being video or, preferably, audio-video.

The device 22 of the controlled user or avatar 30 further comprises video acquisition means 27, preferably audio-video.

The data transceiver means 14 of the device 12 of the usar 20 are adapted to receive from the device 22, in particular from the corresponding data transceiver means 24, over the telematic communication network 35, an audiovisual data stream that corresponds to the scene framed and captured in real time by the avatar 30 during the communication session set up.

Furthermore, the data transceiver means 14 of the device 12 of the usar 20 are adapted to send to the device 22, in particular to the corresponding data transceiver means 24, over the telematic communication network 35, the data items corresponding to the commands imparted in real time by the usar 20 and intended for the avatar 30. In an embodiment, the data items corresponding to the commands are accompanied by a supporting audio data stream.

In a first variation of an embodiment of the interactive telepresence system 10 according to the disclosure, the processing means 16 of the device 12 of the usar 20 are configured to generate a displayable audiovisual content 40 corresponding to the above mentioned input audiovisual data stream.

In a second variation of an embodiment of the interactive telepresence system 10 according to the disclosure, the processing means 16 of the device 12 of the usar 20 are configured to generate a map 44 of the place in the scene framed and captured in real time by the avatar 30, preferably identifying this map from the above mentioned input audiovisual data stream.

In a third variation of an embodiment of the interactive telepresence system 10 according to the disclosure, the processing means 16 of the device 12 of the usar 20 are configured to generate a diagram 48 of an element present in the scene framed and captured in real time by the avatar 30, preferably identifying this element from the above mentioned input audiovisual data stream.

The processing means 16 of the device 12 of the usar 20 are further configured to convert one or more commands, preferably graphical, selected by the usar 20 and intended for the avatar 30, to the corresponding output data items.

In a first variation of an embodiment of the interactive telepresence system 10 according to the disclosure, the user interface means 18 of the device 12 are configured to display and present to the usar 20 a combination of the above mentioned audiovisual content 40, generated by the processing means 16, with a predefined set of selectable commands, preferably graphical, such as for example a perpendicular viewing icon 35.

In a second variation of an embodiment of the interactive telepresence system 10 according to the disclosure, the user interface means 18 of the device 12 are configured to display and present to the usar 20 a combination of the above mentioned map 44 of the place in the scene framed and captured by the avatar 30, such map being generated by the processing means 16, with a predefined set of selectable commands, preferably graphical, such as for example a perpendicular viewing icon 35.

In a third variation of an embodiment of the interactive telepresence system 10 according to the disclosure, the user interface means 18 of the device 12 are configured to display and present to the usar 20 a combination of the above mentioned diagram 48 of an element present in the scene framed and captured by the avatar 30, such diagram being generated by the processing means 16, with a predefined set of selectable commands, preferably graphical, such as for example a perpendicular viewing icon 35.

The user interface means 18 of the device 12 of the usar 20 are further configured to detect the selection of one or more commands, preferably graphical, to be imparted to the avatar 30, by the usar 20, such commands being part of the above mentioned predefined set.

In the present disclosure, an integral part of the commands and of the information sent to the avatar 30 by the usar 20 is the position where the commands, preferably graphical, are observed on the user interface means 18, since this position conveys an important significance of selecting a specific element or portion thereof, on which to execute a required operation, in the scene represented by the audiovisual content 40, in the map 44 of the place in that scene, or in the diagram 48 of an element present in that scene.

In an embodiment of the interactive telepresence system 10 according to the disclosure, the interface means 18 of the device 12 of the controlling user or usar 20 comprise a screen or display and a pointing device.

In an embodiment of the interactive telepresence system 10 according to the disclosure, the interface means 18 of the device 12 of the controlling user or usar 20 comprise a screen or display of the touch screen type, i.e. touch-sensitive.

In an embodiment of the interactive telepresence system 10 according to the disclosure, the interface means 18 of the device 12 of the controlling user or usar 20 comprise at least one loudspeaker.

The data transceiver means 24 of the device 22 of the avatar 30 are adapted to send to the device 12, in particular to the corresponding data transceiver means 14, over the telematic communication network 35, an audiovisual data stream that corresponds to the scene framed in real time by the avatar 30 during the communication session set up.

Furthermore, the data transceiver means 24 of the device 22 of the avatar 30 are adapted to receive from the device 12, in particular from the corresponding data transceiver means 14, over the telematic communication network 35, the data items corresponding to the commands imparted in real time by the usar 20 and intended for the avatar 30. In an embodiment, the data items corresponding to the commands are accompanied by a supporting audio data stream.

The processing means 26 of the device 22 of the avatar 30 are configured to generate, starting from the scene framed by the avatar 30 and captured by the video acquisition means 27, the above mentioned output audiovisual data stream.

The processing means 26 of the device 22 of the avatar 30 are further configured to convert the input data corresponding to one or more commands, imparted by the usar 20 and intended for the avatar 30, to corresponding one or more graphical meta-commands, which comprise for example pictorial images and/or animations, such as for example a perpendicular viewing icon 35, positioned at a specific point of the scene shown by the audiovisual content 40, of the map 44 of the place in that scene, or of the diagram 48 of an element present in that scene.

The video acquisition means 27 of the device 22 are adapted to capture the scene framed in real time by the avatar 30 during the communication session set up, capturing and acquiring the corresponding audiovisual content.

In a first variation of an embodiment of the interactive telepresence system 10 according to the disclosure, the user interface means 28 of the device 22 are configured to display and present to the avatar 30 a combination of the above mentioned audiovisual content 40, corresponding to the scene framed by the avatar 30 and captured by the video acquisition means 27, with the above mentioned one or more graphical meta-commands in a specific position, corresponding to the commands selected previously by the usar 20 and intended for the avatar 30, such as for example a perpendicular viewing icon 35.

In a second variation of an embodiment of the interactive telepresence system 10 according to the disclosure, the user interface means 28 of the device 22 are configured to display and present to the avatar 30 a combination of the above mentioned map 44 of the place in the scene framed by the avatar 30 and captured by the video acquisition means 27, with the above mentioned one or more graphical meta-commands in a specific position, corresponding to the commands selected previously by the usar 20 and intended for the avatar 30, such as for example a perpendicular viewing icon 35.

In a third variation of an embodiment of the interactive telepresence system 10 according to the disclosure, the user interface means 28 of the device 22 are configured to display and present to the avatar 30 a combination of the above mentioned diagram 48 of an element present in the scene framed by the avatar 30 and captured by the video acquisition means 27, with the above mentioned one or more graphical meta-commands in a specific position, corresponding to the commands selected previously by the usar 20 and intended for the avatar 30, such as for example a perpendicular viewing icon 35.

In an embodiment of the interactive telepresence system 10 according to the disclosure, the video acquisition means 27 of the device 22 of the controlled user or avatar 30 comprise a preferably digital still camera or video camera.

In an embodiment of the interactive telepresence system 10 according to the disclosure, the interface means 28 of the device 22 of the controlled user or avatar 30 comprise a screen or display of the touch screen type, i.e. touch-sensitive.

In an embodiment of the interactive telepresence system 10 according to the disclosure, the interface means 28 of the device 22 of the controlled user or avatar 30 comprise at least one loudspeaker. In this case, the interface means 28 can reproduce the supporting audio data stream that accompanies the data corresponding to the commands.

In practice, the interactive telepresence system 10 according to the disclosure overlays a graphical layer of selectable commands on the audiovisual content 40 that represents the scene, on the map 44 of the place in that scene, or on the diagram 48 of an element present in that scene, viewed by the usar 20 and corresponding to the remote scene where that usar 20 wants to be “telepresent”. The graphical layer of commands comprises, in particular, a predefined set of selectable commands which are variously organized according to requirements, for example in the form of a menu.

In practice, furthermore, the interactive telepresence system 10 according to the disclosure overlays a graphical layer of graphical meta-commands, corresponding to the commands selected previously by the usar 20, on the audiovisual content 40, on the map 44, or on the diagram 48, viewed by the avatar 30 and corresponding to the scene framed in real time by that avatar 30.

In the present disclosure, an integral part of the interactive telepresence system 10 is the position where the graphical meta-commands are displayed and presented to the avatar 30 on the user interface means 28, since this position conveys an important significance of selecting a specific element or portion thereof, on which to execute a required operation, in the scene represented by the audiovisual content 40, in the map 44 of the place of that scene, or in the diagram 48 of an element present in that scene.

Thus, the avatar 30 views the graphical meta-commands, imparted by selection by the usar 20 and intended for the avatar 30, on the audiovisual content 40, on the map 44, or on the diagram 48 corresponding to the scene framed in real time by the avatar 30, and understands immediately, for example, on what point of the scene the usar 20 wants to act and/or what kind of operation the usar 20 wants to be performed.

Different gestures or selection of commands by the usar 20 are converted, by the interactive telepresence system 10 according to the disclosure, to corresponding graphical meta-commands, which comprise for example pictorial images and/or animations, such as for example a perpendicular viewing icon 35, displayed directly on the interface means 28 of the device 22 of the avatar 30.

Note that the use of pictorial images and/or animations compensates for the problem of the possible difference in languages spoken by usar 20 and avatar 30.

By way of example, the usar 20 can impart to the avatar 30, using the interactive telepresence system 10 according to the disclosure, movement or displacement commands, such as for example: forward, backward, left, right, go to a point indicated in the scene, stand at right angles to an element or at a point in the scene, and so on.

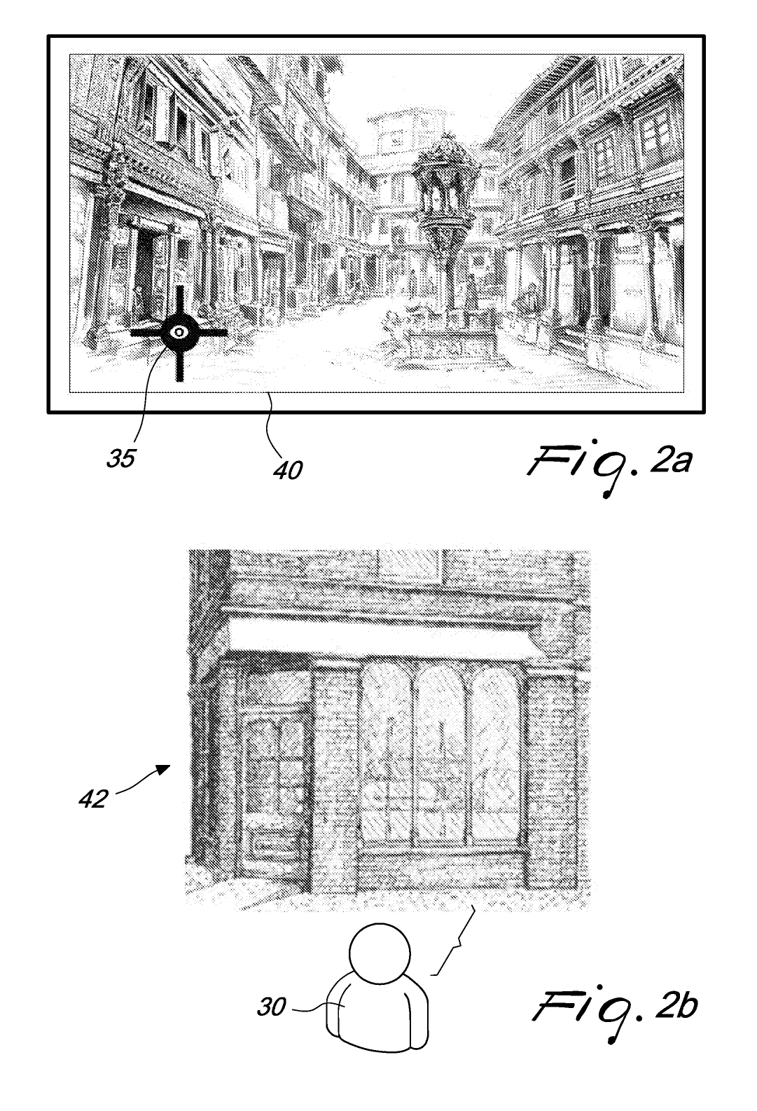

In particular, the positioning of graphical meta-commands for movement on a specific element in the scene makes it possible to impart to the avatar 30 a high-level command that summarizes a whole sequence of low-level movement commands that would be necessary to guide the avatar to the desired point. With reference for example to what is shown in FIGS. 2a and 2b, consider a city street and the request from the usar 20 to stand in front of a shop window some distance from the avatar 30, visible in the distance in the scene in the audiovisual content 40: without the system for positioning the graphical meta-commands comprised in the interactive telepresence system 10 according to the disclosure, the usar 20 would have to send a long sequence of movement and positioning commands to go forward, stop at the traffic light, turn, cross the street, turn again, go forward again, turn, and sidestep left and right until the avatar 30 is perpendicular to the required shop window.

By assigning an operational significance to the coordinates on the interface means 18 of the device 12 on which the usar 20 selects a single graphical positioning command, the avatar 30 receives a high-level request that summarizes what it is to do and where it is to act, delegating to it the complex sequence of basic commands necessary to achieve the objective.

Again for example, the usar 20 can impart to the avatar 30, using the interactive telepresence system 10 according to the disclosure, manipulation commands, such as for example: pick up an element of the scene, rotate an element of the scene, actuate an element of the scene, acquire an element of the scene, and so on.

The position, i.e. the coordinates, on the interface means 18 and 28 at which the command is respectively imparted by the usar 20 and viewed by the avatar 30, on the audiovisual content 40 that represents the scene, on the map 44 of the place in that scene, or on the diagram 48 of an element present in that scene, makes it possible to convey a high-level request that avoids a long sequence of basic commands for movement and/or for panning the video acquisition means 27 in order to reach the element, take up a suitable position with respect to it and act on it.

Again by way of example, the usar 20 can impart to the avatar 30, using the interactive telepresence system 10 according to the disclosure, commands to manage the framing, such as for example: zoom on an element or a point of the scene, follow an element in the scene in motion, orbit around an element in the scene, and so on.

These commands can be low-level or high-level. In the second case, they depend on an additional item of information which is the position, i.e. the coordinates, on the interface means 18 and 28 at which the command is respectively imparted by the usar 20 and viewed by the avatar 30, on the audiovisual content 40 that represents the scene, on the map 44 of the place in that scene, or on the diagram 48 of an element present in that scene.

By virtue of this aspect of the disclosure, the avatar 30 receives an item of information in addition to the simple command icon, which makes it possible to request high-level framing functionalities. For example, the orbital framing command requests the avatar 30 to move the framing along a circular path while keeping the element on which the function is requested at the center. Similarly, the command to take up a position perpendicular to the element substitutes a complex series of low-level movement commands to reach the desired framing, leaving it to the avatar 30 to manage the movement procedure completely.

It is evident to the person skilled in the art that the commands, and therefore the corresponding graphical meta-commands, can number many more than those given here for the purposes of example, according to requirements.

It is likewise evident that the technique of assigning an important item of information to the position, i.e. the coordinates, of the graphical representation of the meta-command on the audiovisual content 40 that represents the scene, on the map 44 of the place in that scene, or on the diagram 48 of an element present in that scene, makes it possible to take advantage of the fact that the avatar 30 is a human being and as such is capable of proceeding autonomously with the entire sequence of low-level commands necessary in order to carry out the requested high-level function on the indicated element.

An example that makes clear the use of coordinates to superimpose an icon 35 with a high-level command over the audiovisual content 40 that represents the scene is shown in FIGS. 2a and 2b: simply by positioning a perpendicular viewing icon 35 on a shop window on a street that is in the frame, the avatar 30 understands that this is the element in the scene to be brought to the center of the frame and that the avatar 30 itself is to take up a position perpendicular to it. The sequence of basic commands to pass from the initial framing of the street, shown in the audiovisual content 40, to the final framing 42 of the shop window would be very complex in the absence of the semantic positioning technique of the icon 35.

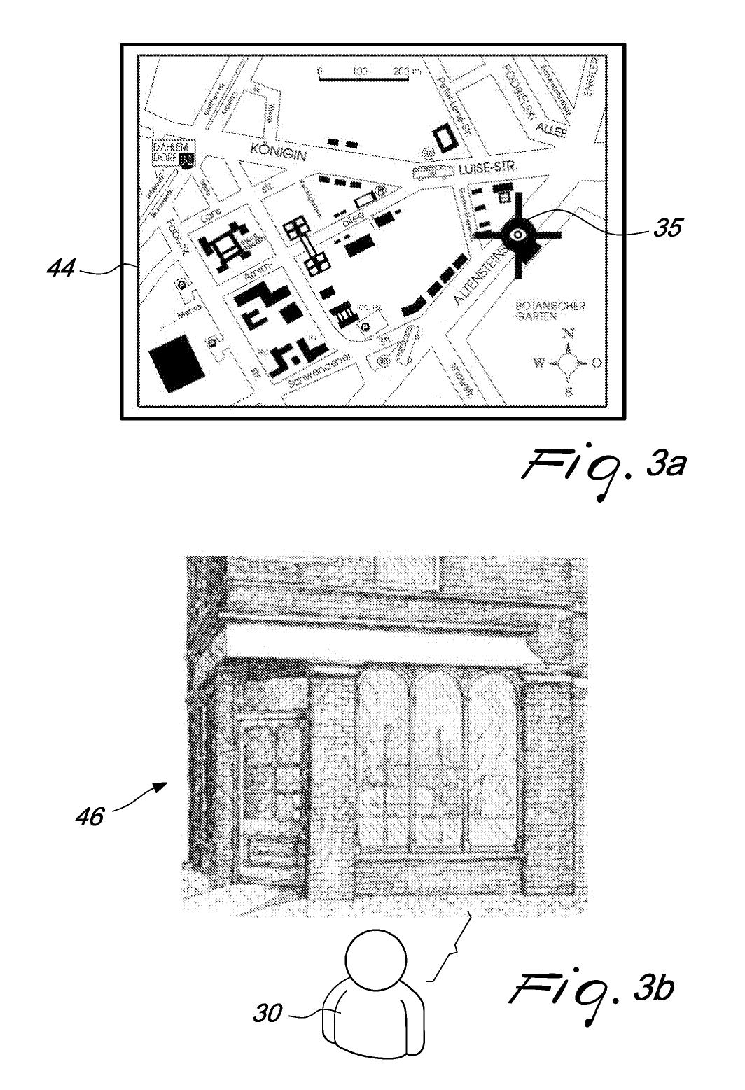

Another example that makes clear the use of coordinates to superimpose an icon 35 with a high-level command over a map 44 of the place in the scene is shown in FIGS. 3a and 3b: simply by positioning a perpendicular viewing icon 35 on an element on the map 44, the avatar 30 understands that this is the element in the scene to be brought to the center of the frame and that the avatar 30 itself is to go to the point indicated, and then take up a position perpendicular to it. The sequence of basic commands to pass from the initial position of the avatar 30 on the map 44 to the final framing 46 of the shop window would be very complex in the absence of the semantic positioning technique of the icon 35.

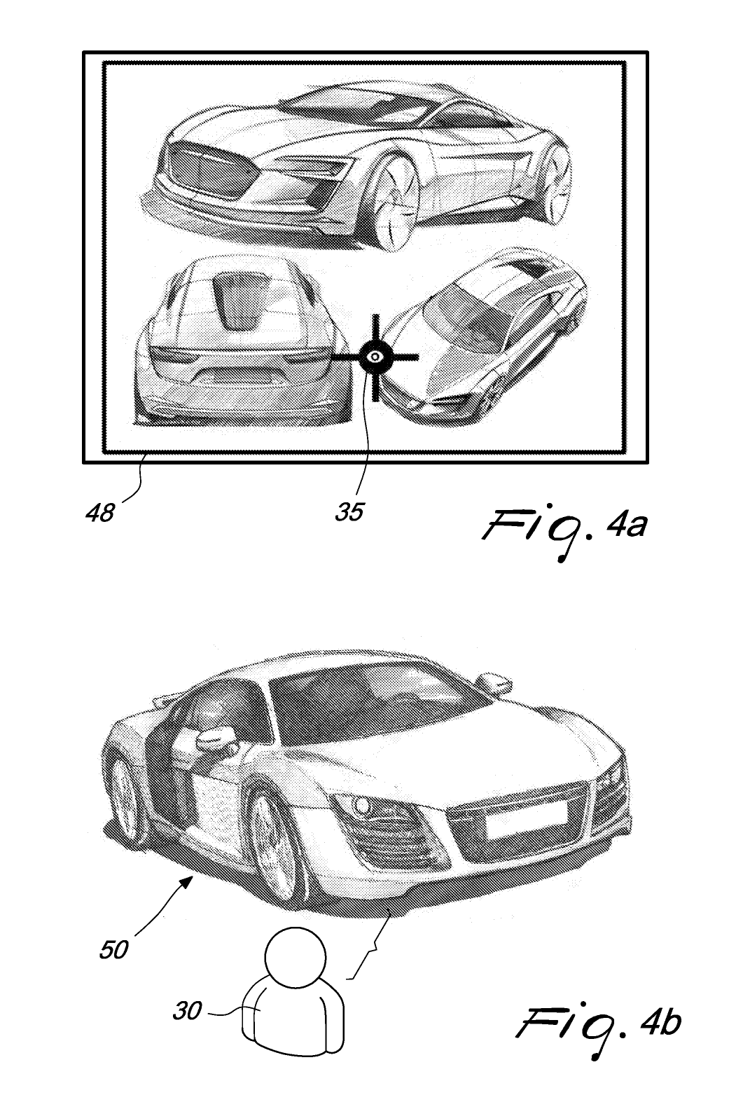

Another example that makes clear the use of coordinates to superimpose an icon 35 with a high-level command over a diagram 48 of an element present in the scene is shown in FIGS. 4a and 4b: simply by positioning a perpendicular viewing icon 35 on a point of the diagram 48, the avatar 30 understands that this is the part of the element present in the scene to be brought to the center of the frame and that the avatar 30 itself is to take up a position perpendicular to it. The sequence of basic commands to pass from the initial position of the avatar 30 to the final framing 50 would be very complex in the absence of the semantic positioning technique of the icon 35.

In an embodiment of the disclosure, the interactive telepresence system 10 comprises a system for sharing electronic documents or data files between the device 12 of the usar 20 and the device 22 of the avatar 30.

In practice, the device 22 of the avatar 30 can receive, in particular through the corresponding data transceiver means 24, electronic documents or data files originating from the device 12 of the usar 20, in particular sent from the corresponding data transceiver means 14.

The device 22 of the avatar 30 can further send, in particular through the corresponding data transceiver means 24, electronic documents or data files to the device 12 of the usar 20, in particular to the corresponding data transceiver means 14, since it can easily insert connectors and carry out simple operations on personal computers and other apparatuses with the entry of access codes, email addresses or telephone numbers.

In an embodiment of the disclosure, the interactive telepresence system 10 comprises a system for fixing the device 22, in the form of a smartphone or tablet computer, to the body of a person, in particular to the body of the controlled user or avatar 30, in order to enable the activities of the avatar 30 to be conducted unhindered, furthermore meeting the requirements of stability of framing and of capture, and of usability for a long time with multiple requests for framing by the controlling user or usar 20.

In a preferred embodiment of the interactive telepresence system 10 according to the disclosure, the system for fixing the device 22 comprises substantially a harness or system of straps and a telescopic rod or arm, the latter being provided on its top with a spring-loaded mechanism capable of holding and immobilizing a vast range of different mobile devices, therefore adaptable to many and varied models of smartphone or tablet computer.

The telescopic arm has a handle placed at its base and such handle is inserted into a tubular element, which is closed at the lower end and padded.

The tubular element is fixed to the system of straps, in particular its lower closed end is fixed to a first strap that runs around the neck of the controlled user or avatar 30. This first strap is adjustable in length and has a quick-release mechanism.

A second strap, which also runs around the neck of the controlled user or avatar 30, is provided with a support ring through which passes, in a higher position with respect to the handle, the part of the telescopic arm that emerges from the tubular element. This second strap is also adjustable in length and has a quick-release mechanism.

The system of straps further comprises a tubular padding inside which the straps pass, which is adapted to reduce the friction of such straps on the back of the neck of the controlled user or avatar 30.

The controlled user or avatar 30 holds in his/her hand the padded tubular element, into which the handle of the telescopic arm is inserted, and thus controls the position of the device 22 with his/her movements.

In practice it has been found that the disclosure fully achieves the set intentions and advantages. In particular, it has been seen that the interactive telepresence system thus conceived makes it possible to overcome the qualitative limitations of the known art, since it makes it possible to set up a telepresence that is effectively interactive, i.e. recreate in the remote user the sensation, as convincing as possible, of being in a different place from where he/she is physically.

Another advantage of the interactive telepresence system according to the disclosure is that it makes it possible to easily move the point of view, especially in medium to long distances, thus overcoming the limited scope of office meetings, typical of videoconferencing products, and it makes it possible for the remote user to leave buildings or delimited areas and explore outside environments, including urban environments.

Another advantage of the interactive telepresence system according to the disclosure is that it is not limited to precise control, step by step, using basic icons for moving and/or panning, which respectively represent individual movements to move the controlled user in the field and to change the position and/or orientation of video capture, as well as interact with elements in the scene framed and captured.

Another advantage of the interactive telepresence system according to the disclosure is that it takes advantage of the fact that the controlling user is controlling a human being, who is able to navigate and move around autonomously in the field and to autonomously pan the video capture device or apparatus, following high-level objectives indicated by the controlling user which require complex sequences of low-level actions.

Another advantage of the interactive telepresence system according to the disclosure is that it makes it possible to take advantage of the autonomous capacities for navigation and movement of the avatar 30, by sending high-level commands that are completely different from the low-level commands relating to individual steps of movement and/or of panning, appealing to its ability to formulate and execute a plan of navigation and movement that results in the execution of the requested operation on the specific element in the scene, indicated by way of the convention of significance of the position, i.e. of the coordinates, for displaying the graphical command.

Another advantage of the interactive telepresence system according to the disclosure is that the information about the position of the graphical command can be conveyed through the display position, i.e. the coordinates, on the instantaneous audiovisual content that represents the scene, on a map of the place in that scene, or on a diagram of an element present in that scene.

Another advantage of the interactive telepresence system according to the disclosure is that it enables telemanipulation by the remote user, i.e. the possibility to act physically and indirectly on objects present in the remote environment viewed, for the purpose for example of positioning them differently on the scene in order to observe them better, or in order to buy them, actuate them or modify them.

Another advantage of the interactive telepresence system according to the disclosure is that it makes it possible to indicate the element on which to interact, as well as the kind of interaction required, by way of an additional item of information which is the position on the interface means on which the command is imparted to the usar 20 and viewed by the avatar 30, respectively, on the instantaneous audiovisual content that represents the scene, on a map of the place in that scene, or on a diagram of an element present in that scene.

Another advantage of the interactive telepresence system according to the disclosure is that it does not require the parties in communication, be they persons or artificial systems, to have an apparatus that is compatible and is connected to the internet, or to install an adapted program on their computer or mobile device.

Another advantage of the interactive telepresence system according to the disclosure is that it limits to the minimum operating complexities, thus facilitating the remote user in having awareness of the surrounding environment, and legal complexities.

Although the interactive telepresence system according to the disclosure has been devised in particular for indirectly manipulating remote objects, for indirectly using remote machines and for indirectly driving remote vehicles by persons, or artificial systems, it can however be used, more generally, for communication and audiovisual dialog between persons located in different places, no matter how distant, i.e. in all cases in which it is desired to enable the presence of persons, or artificial systems, in places other than the place where they are physically located.

One of the possible uses of the interactive telepresence system 10 according to the disclosure is a generic service whereby a person or an artificial system, i.e. the controlled user or avatar 30, becomes available to another person or artificial system, i.e. the controlling user or usar 20, which controls it and guides it remotely, through the telematic communication network 35.

In general, the applications of the interactive telepresence system according to the disclosure are numerous and comprise the possibility of performing activities of tourism, exploration, maintenance, taking part in business meetings, taking part in sporting, cultural or recreational events and, more generally, everything that a person or an artificial system can do, without necessarily having to go to the specific place, i.e. remotely.

By way of example, teleshopping services are possible, offered by shopping centers where the remote customers are accompanied remotely in the retail spaces by sales assistants and/or combinations of hybrid drones capable of fulfilling multiple orders from remote customers, in order to then send them in a centralized manner, thus offering an e-commerce service to shopkeepers that do not have their own remote sales system.

Again for example, services are possible in which the controlled users are constantly in motion along areas of interest, such as for example tourist areas or commercial areas, ready to be guided by a controlling user.

Again by way of example, it is possible to have teleassistance packages provided by controlled users of varying levels of expertise to carry out usage or maintenance operations on machines and systems installed at industrial sites, so as to reduce the travel costs of operators or of specialist technicians.

Similarly, it is possible to have teleassistance and/or teleinstruction packages provided by highly-qualified and specialist controlling users to supervise or guide usage or maintenance operations on machines and systems installed at industrial sites, so as to keep high the quality of the work or of the maintenance even in the absence of operators or specialist technicians on site.

Using machines and systems with the interactive telepresence system according to the disclosure makes it possible to reduce the cost of staff for the simpler tasks, such as for example the use of reach trucks, which can be done by persons located in places where the cost of labor is lower.

The disclosure, thus conceived, is susceptible of numerous modifications and variations. Moreover, all the details may be substituted by other, technically equivalent elements.

In practice, the materials used, as well as the contingent shapes and dimensions, may be any according to the requirements and the state of the art.

The disclosures in Italian Patent Application No. 102016000010724 (UB2016A000168) from which this application claims priority are incorporated herein by reference.

1. An interactive telepresence system comprising: a first device operated by a controlling user and a second device operated by a controlled user, in communication with each other over a telematic communication network, said first device and said second device comprising data transceiver means, processing means and user interface means, said second device further comprising video acquisition means wherein said processing means of said second device are configured to convert input data corresponding to one or more commands, intended for said controlled user, to corresponding one or more graphical meta-commands, and in that said user interface means of said second device are configured to display and present to said controlled user a combination of an audiovisual content, which corresponds to a scene acquired by said video acquisition means, with said one or more graphical meta-commands.

2. The interactive telepresence system according to claim 1, wherein said graphical meta-commands comprise pictorial images and/or animations.

3. The interactive telepresence system according to claim 1, wherein said user interface means of said first device are configured to display and present to said controlling user a combination of said audiovisual content with a predefined set of selectable commands.

4. The interactive telepresence system according to claim 3, wherein said user interface means of said first device are further configured to detect the selection of said one or more commands, intended for said controlled user, by said controlling user, said one or more commands being part of said predefined set of selectable commands.

5. The interactive telepresence system according to claims 1, wherein said video acquisition means of said second device comprise a still camera or video camera.

6. The interactive telepresence system according to claims 1, wherein said user interface means of said first device comprise a screen or display and a pointing device.

7. The interactive telepresence system according to claims 1, wherein said user interface means of said first device and said second device comprise a screen or display of the touch screen type.

8. The interactive telepresence system according to claims 1, wherein said user interface means of said first device and said second device comprise at least one loudspeaker.

9. The interactive telepresence system according to claims 1, further comprising a system for sharing electronic documents or data files between said first device of said controlling user and said second device of said controlled user.

10. The interactive telepresence system according to claims 1, further comprising a system for fixing said second device to the body of said controlled user.
